(19) United States
(12) Patent Application Publication
(10) Pub. No.: US 2016/0317989 A1
(43) Pub. Date: Nov. 3, 2016

(54) Water-Driven Device, System and Method for Aerating or Mixing a Body of Water

(71) Applicant: ZEMA Oxipool, Netanya (IL)

(72) Inventors: Ehud NAGLER, Kiryat Tivon (IL); Miki MICHAELI, Bait Shean Valley (IL); Zvi YEMINI, Tel Aviv (IL)

(21) Appl. No.: 14/699,638

(22) Filed: Apr. 29, 2015

(51) Int. Cl. B01F 15/00; B01F 13/00; A01K 63/04; B01F 15/02; C02F 1/74; B01F 3/04; B01F 7/04

(52) U.S. Cl. CPC B01F 15/00545; B01F 3/04588; B01F 13/0049; B01F 7/04; B01F 15/0243; C02F 1/74; B01F 3/04439; A01K 63/042; C02F 2201/002; B01F 2003/04872; B01F 2215/008

(57) ABSTRACT

A device for aerating or mixing a body of water has a mechanical displacer driven by connection to a hydraulic motor such that a flow of liquid supplied to the inlet moves the mechanical displacer so as to displace water of the body of water. The device may be supported by floats or mounted on a fixed structure. The device is preferably actuated b a flow of water delivered via tubing from a pump located remotely from the body of water, thereby avoiding, the wet-environment shock hazard of electrically driven aerators and mixers.

### FIELD AND BACKGROUND OF THE INVENTION

The present invention relates to systems for aerating or mixing a body of water and, in particular, it concerns a device, system and method for aerating or mixing a body of water employing a hydraulic motor.

It is known to employ mechanical aerators for increasing dissolved oxygen in bodies of water for applications such as fish ponds and water treatment. A typical mechanical aerator design employs a paddle wheel partially immersed in the water that is rotated by an electric motor so as to disrupt the surface of the water and constantly splash amounts of water into a spray cloud with significant surface area, allowing absorption of oxygen from the air and thereby increase the dissolved oxygen in the body of water. Other similar devices are used to mix and circulate water within pools.

The use of electrical appliances in a wet environment poses a significant safety risk, and electrocution has become one of the principle occupational hazards of workers involved in managing fish farms and water treatment facilities.

### SUMMARY OF THE INVENTION

The present invention is an aerator or mixing device, system and method.

According to the teachings of an embodiment of the present invention there is provided, a device for aerating or mixing a body of water, the device comprising: (a) a mechanical displacer movable so as to displace water of the body of water, thereby aerating or mixing the body of water, and (b) a hydraulic motor have an inlet for receiving a flow of liquid the hydraulic motor being connected in driving relation to the mechanical displacer such that a flow of liquid supplied to the inlet is effective to move the mechanical displacer so as to displace water of the body of water.

According to a further feature of an embodiment of the present invention, the mechanical displacer is an aerator comprising a rotating wheel.

According to a further feature of an embodiment of the present invention, the mechanical aerator comprises a paddle wheel supporting a plurality of outwardly-projecting paddles.

According to a further feature of an embodiment of the present invention, the mechanical displacer and the hydraulic motor are mounted on a buoyant platform comprising at least one float, the buoyant platform being configured to maintain the mechanical displacer in a partially-immersed of fully-immersed state.

According to a further feature of an embodiment of the present invention, the hydraulic motor is a rotary motor.

According to a further feature of an embodiment of the present invention, the rotary motor has a rotating output. shaft linked so as to rotate at least part of the mechanical displacer.

According to a further feature of an embodiment of the present invention, at least part of the mechanical displacer is integrated with a casing of the rotary motor, and wherein the rotary motor is configured to drive rotation of the casing relative to a fixed axis.

According to a further feature of an embodiment of the present invention, the hydraulic motor is a positive-displacement motor.

According to a further feature of an embodiment of the present invention, the hydraulic motor has an outlet deployed to release the flow of liquid, and wherein the outlet is deployed such that, when the hydraulic motor is driven by a flow of water, the water is released via the outlet into the body of water.

According to a further feature of an embodiment of the present invention, the device has no externally-powered electric component.

There is also provided according to the teachings of an embodiment of the present invention, a system for aerating a body of water, the system comprising: (a) the aforementioned device deployed at least partially immersed in the body of water; (b) a water pump deployed remotely relative to the body of water; and (c) a length of tubing connected to an outlet of the water pump and to the inlet of the hydraulic motor so as to deliver a flow of water from the water pump to the hydraulic motor, thereby driving the mechanical displacer.

According to a further feature of an embodiment of the present invention, there is also provided a conduit deployed for drawing water from the body of water to an inlet of the water pump such that the hydraulic motor is driven by a flow of water drawn from the body of water.

According to a further feature of an embodiment of the present invention, the water pump is connected via additional lengths of tubing for driving a plurality of devices deployed in a plurality of bodies of water.

There is also provided according to the teachings of an embodiment of the present invention, a method for aerating or mixing a body of water comprising the steps of (a) deploying the aforementioned device at least partially immersed in the body of water; and (b) supplying to the hydraulic motor a flow of water so as to actuate the hydraulic motor, thereby moving the mechanical displacer so as to displace water of the body of water, thereby aerating or mixing the body of water.

### BRIEF DESCRIPTION OF THE DRAWINGS

The invention is herein described, by way of example only, with reference to the accompanying drawings, wherein:

FIG. 1 is a schematic overview of an aerator system, constructed and operative according to an embodiment of the present invention, for aerating a number of bodies of water;

FIG. 2 is a schematic isometric view of an aerator device according to a first embodiment of the present invention for use in the system of FIG. 1;

FIG. 3 is a schematic exploded isometric view of the aerator device of FIG. 2;

FIGS. 4 and 5 are schematic isometric views of a hydraulic motor suitable for use in the device of FIG. 1, these figures corresponding to FIGS. 8 and 9 of U.S. Pat. No. 7,258,057;

FIG. 6 is a schematic isometric view of an aerator device according to a further embodiment of the present invention for use in the system of FIG. 1;

FIG. 7 is a partially cut-away view of the aerator device of FIG. 6;

FIG. 8 is an isometric view of a device similar to one half of the device of FIG. 2, mounted on a vertical rail for mounting in a partially-immersed or fully-immersed level in a vertical-walled pool; and

FIG. 9 is an isometric view of a device for circulating water within a body of water according to a further implementation of the present invention.

### DESCRIPTION OF THE PREFERRED EMBODIMENTS

The present invention is a device for aerating or mixing a body of water, and a corresponding system and method.

The principles and operation of devices according to the present invention may he better understood with reference to the drawings and the accompanying description.

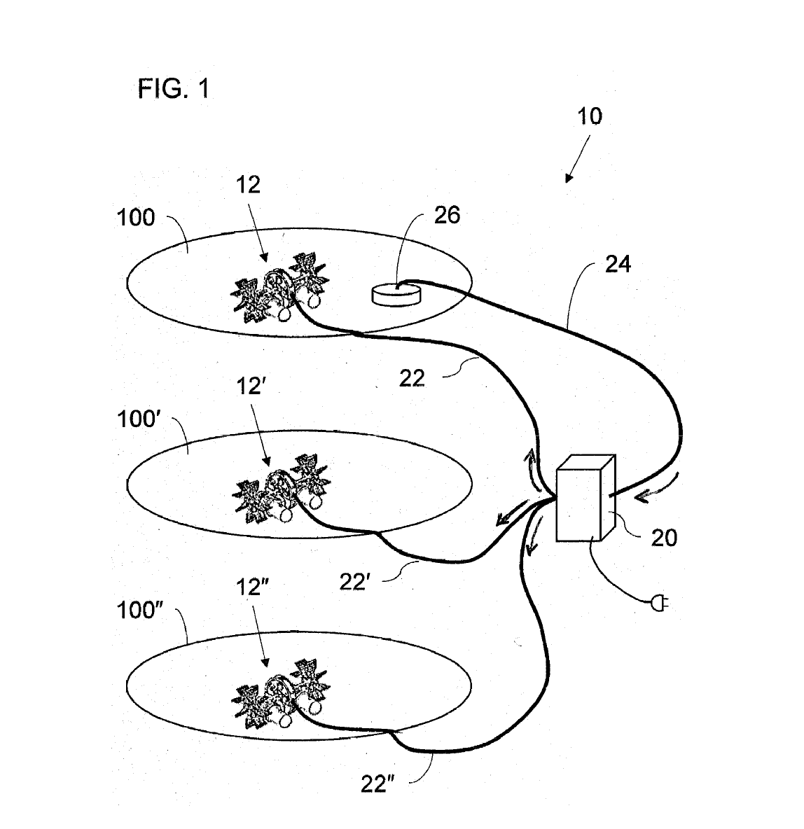

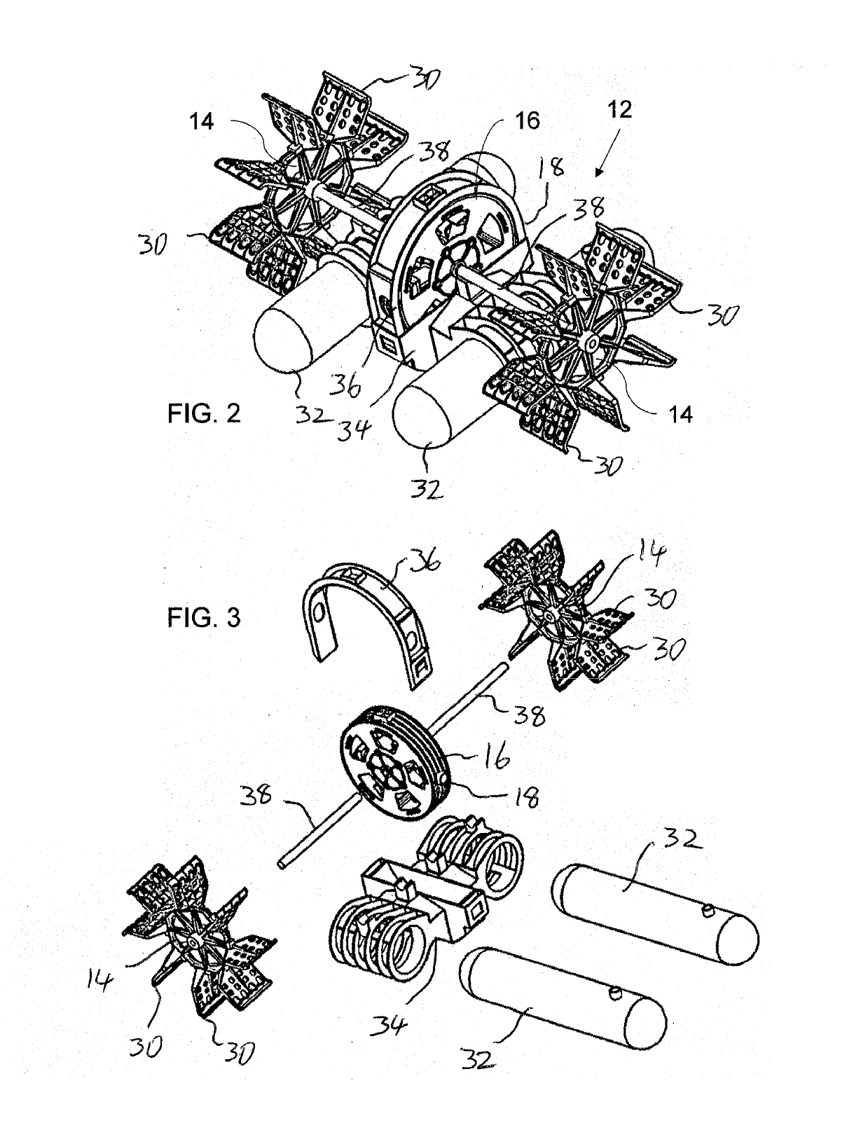

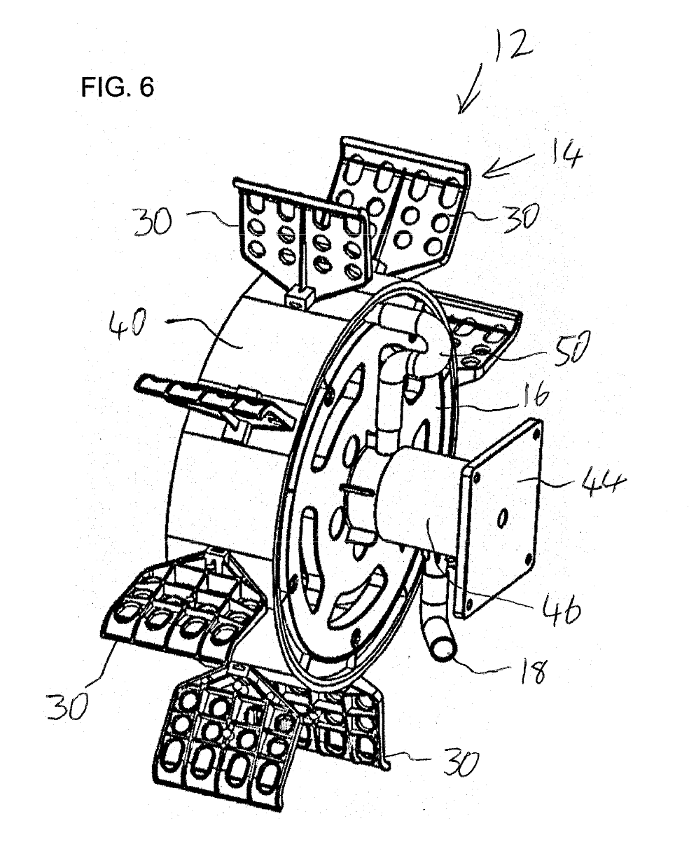

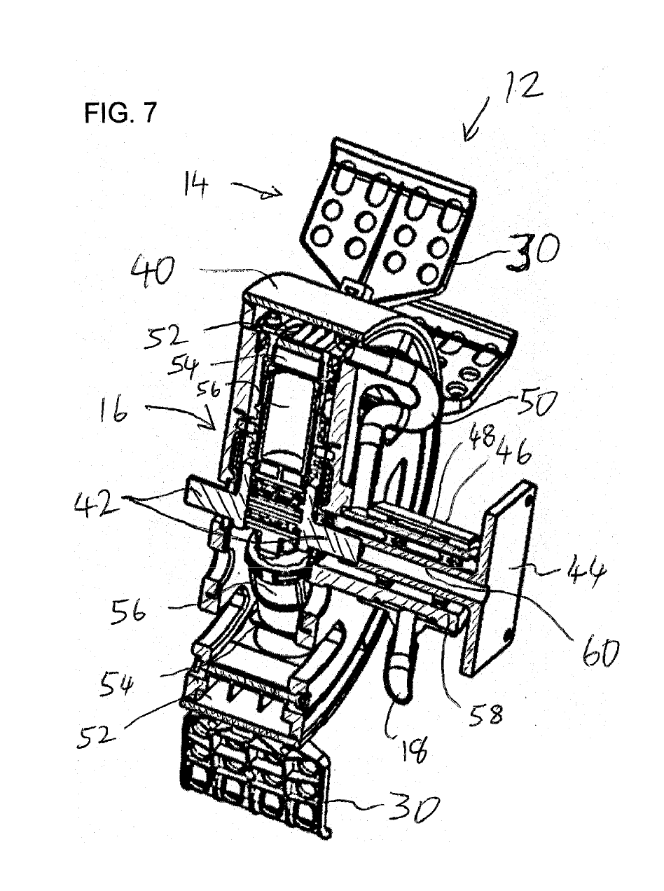

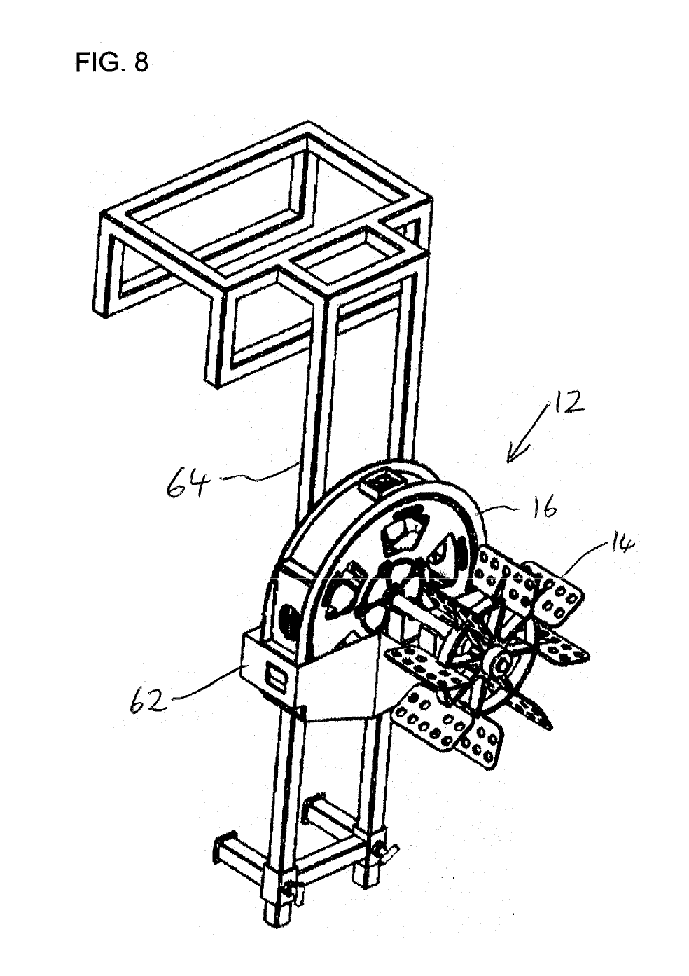

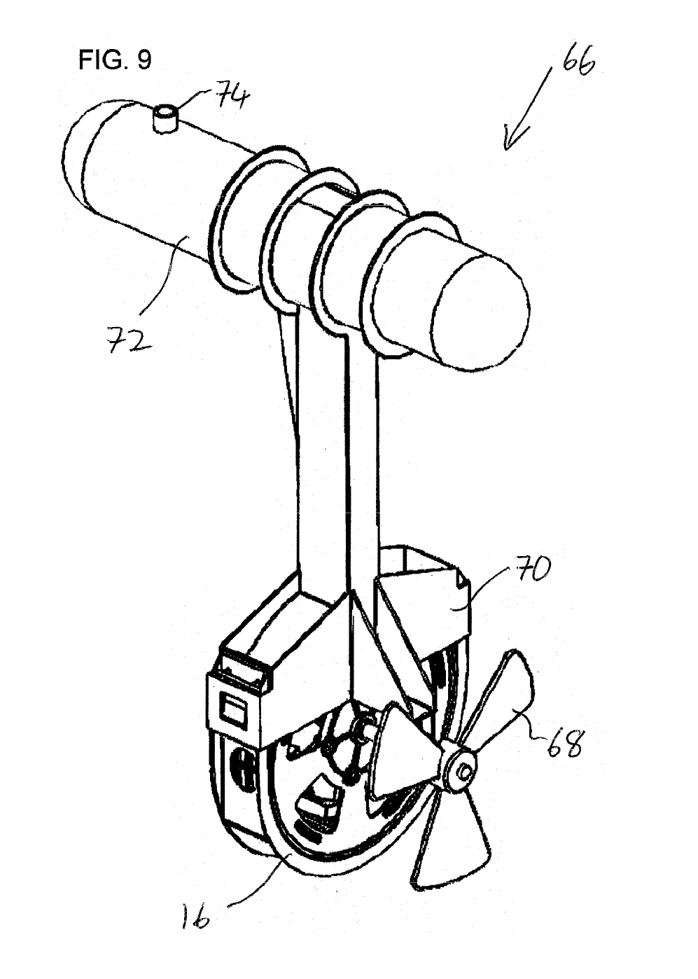

Referring now to the drawings, FIG. 1 shows schematically an overview of a system, generally designated 10, including a device 12, constructed and operative according to an embodiment of the present invention, for aerating and/or mixing at least one body of water 100, 100′, 100″. A first exemplary embodiment of device 12 is illustrated in more detail in FIGS. 2-5, while a second exemplary embodiment of device 12 is illustrated in FIGS. 6 and 7. The same reference numerals will be used to refer to analogous components. In the primary but non-limiting example illustrated here, device 12 is an aerator which splashes a spray of droplets upwards from the water, thereby increasing the dissolved oxygen content of the water and hence of the whole pool. It should he noted, however, that the same principles are applicable to immersed circulation/mixing devices, as will be discussed further below with reference to FIGS. 8 and 9.

In general terms, device 12 includes a mechanical displacer (aerator) 14 movable so as to displace water of the body of water, and a hydraulic motor 16 connected in driving relation to mechanical aerator 14 such that a flow of liquid supplied to an inlet 18 of hydraulic motor 16 is effective to move mechanical aerator 14 so as to disrupt a surface of the body of water, thereby increasing a dissolved oxygen content of the body of water.

On a system level, as illustrated in FIG. 1, device 12 is deployed partially immersed in the body of water. An electric pump, typically a water pump 20, deployed remotely relative to the body of water, supplies a flow of liquid via a length of tubing 22 from an outlet of the water pump to the inlet of hydraulic motor 16, thereby driving mechanical aerator 14.

In certain preferred embodiments where water is used as the hydraulic fluid, a conduit 24 may advantageously be deployed for drawing water, preferably via a filter 26, from body of water 100 to an inlet of water pump 20 such that hydraulic motor 16 is driven by a flow of water drawn from the body of water. Alternatively, water may be drawn from another source. Where a mains water supply is available, the power to drive the aerator may optionally be derived from the pressurized water supply such that the function of the “pump” of the system may be performed by the pumping system of the water utility. In certain embodiments (not shown), a closed-loop hydraulic circuit may be used, with spent fluid from an outlet of the hydraulic motor being piped back to pump 20, directly or via a dedicated reservoir.

At this stage, it will be appreciated that various implementations of the present invention make a considerable contribution to the safety of aerator systems. Specifically, by employing hydraulic power to drive aerator devices 12, the hazards resulting from use of electrical equipment in a wet environment are essentially circumvented. The pump, which may be electrically powered, is located remotely from the body of water, such that this also does not pose a wet-environment shock hazard.

It should be noted that the phrase “hydraulic motor” is used herein in the description and claims to refers generically to any and all motors and actuators that are driven by a flow of fluid, and most preferably by a flow of liquid. Hydraulic motors according to this definition can be broadly subdivided into two classes, referred to herein as “positive displacement motors” and “momentum transfer motors.” In this context, a “positive displacement motor” may be defined as a motor which, if blocked from motion, will also substantially block the liquid flow. In positive displacement motors, torque is obtained from static pressure of the driving fluid. Examples of positive displacement motors include, but are not limited to, vane motors, gear motors, gerotor motors and piston motors. A “momentum transfer motor” is a motor in which motion/torque is generated by transfer of momentum from a stream of fluid impinging on surfaces of the motor (“dynamic pressure”). Examples of momentum transfer motors include, but are not limited to, various types of turbine devices. All of the above types of hydraulic motor are believed to be feasible for implementing the present invention. For certain preferred embodiments, positive displacement motors are believed to he advantageous. One particularly preferred option illustrated below is the use of a piston motor.

The hydraulic fluid employed to power the hydraulic motor of the present invention may be any fluid, but is most preferably a liquid. An option of using a closed hydraulic system (with or without a reservoir/buffer) falls within the scope of the invention, and could be implemented using oil-based hydraulics. However, particular economy and simplicity of implementation may he achieved by using water as the hydraulic fluid. This allows drainage from an outlet of the hydraulic motor directly into the body of water, without requiring a return flow tube connected to the motor outlet. In this context, it should be noted that the term “water” is used to refer generically to clean or contaminated (waste) water, seawater and other water-based solutions. In some eases, the water used to drive the hydraulic motor may contain certain additives such as, for example, a water treatment or conditioning chemical, or a medication needed for treatment of fish. These additives are then released into the body of water from the outlet of the hydraulic motor.

The term “remote” is used to refer to positioning of pump 20 at a location out of contact with the water, and at a sufficient spacing from the body of water that it is not considered to pose a wet-environment shock hazard. The required distance depends upon the circumstances, but a distance of a few meters is typically sufficient, and with other suitable safety precautions, even smaller distances may be considered sufficient, as is known in the art.

In certain applications, such as intensive fish farming, where the farming system typically includes a forced-flow pump for circulating water within each pool, pump 20 may in fact be the standard water circulating pump of the farming system. In this case, a branch pipe is typically added to route an appropriate quantity of pressurized water to aerator device 12 while the remainder of the flow returns to the pool via the primary circulation channels.

A single pump 20 may be used to supply a flow of water via additional lengths of tubing 22′, 22″ for driving additional aerator devices 12′, 12″ deployed in a plurality of bodies of water 100′, 100″. Similarly, for larger pools, two or more aerator devices 12 may he deployed for aerating a single pool (not shown).

The present invention may be used to advantage in a wide range of applications in which aeration and/or circulation/mixing of a body of water, any other liquid, is required. Primary examples include extensive fish farming, intensive fish farming, other types of aquaculture, and various types of treatment of waste water or sewage. The invention may also be applied to advantage in the chemical industry a id the food industry.

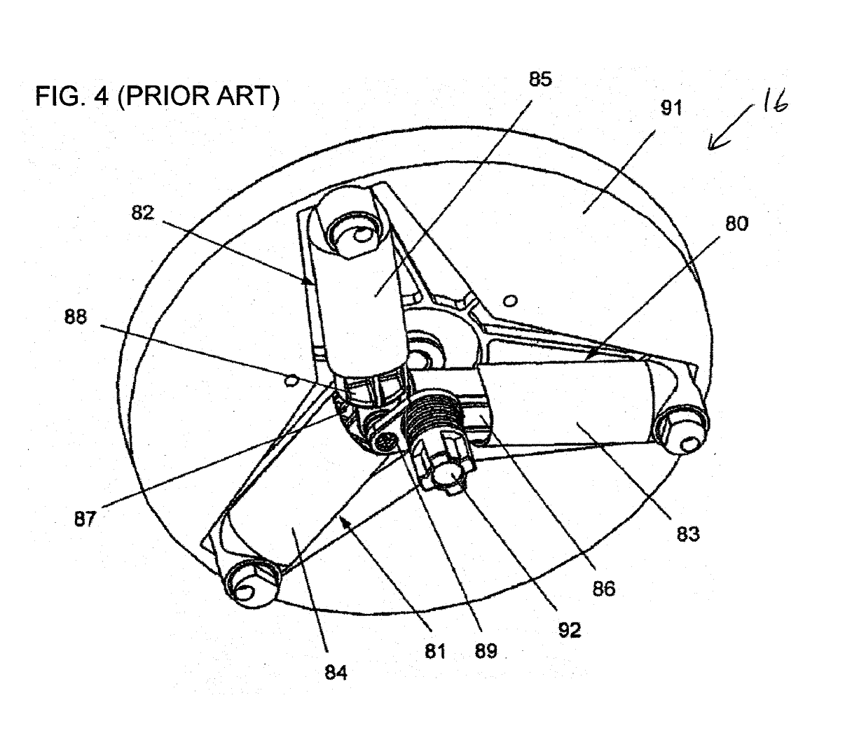

Turning now to a first ion-limiting exemplary embodiment of aerator device 12, this is shown in FIGS. 2-5. A wide range of structures may be used to implement mechanical aerator 14. A particularly simple and reliable subset of options employ a rotating wheel, such as for example, a rotating paddle wheel supporting a plurality of outwardly-projecting paddles 30. The form of the paddle wheels per se may be implemented in a manner similar to a conventional (electric) paddle-wheel aerator. Such paddle wheels disrupt the water surface, generating an upward spray of water which becomes aerated and falls back to the body of water, thereby increasing the dissolved oxygen in the water. In the version of device 12 illustrated in FIGS. 2 and 3, a pair of paddle-wheel aerators 14 are deployed symmetrically at opposite sides of the device. A single paddle-wheel design, or devices employing three or more paddle wheels, also fall within the scope of the invention.

For effective operation, the mechanical aerator should typically be maintained in a predefined partially-immersed state. For example, in the case of a paddle wheel aerator, the paddles should typically be immersed when in their lowest position but should be clear of the water during the majority of their motion. This typically corresponds to immersion to a depth of between about 20% and about 40% of the outer diameter of the paddle wheel. In order to maintain the desired degree of immersion, mechanical aerator 14 and hydraulic motor 16 are preferably mounted on a buoyant platform comprising at least one float 32. In the non-limiting example illustrated here, the buoyant platform includes a frame 34 configured for receiving a pair of floats 32, and with features (including a clamping band 36) for supporting hydraulic motor 16 and mechanical aerator 14, thereby defining the desired extent of partial-immersion.

For a rotary mechanical aerator 14, hydraulic motor 16 is advantageously implemented as a rotary motor. As mentioned above, many different types of hydraulic motor may be used to implement the present invention. In this case, a particularly simple implementation may employ direct connection of a rotating output shaft 38 of the motor to the mechanical aerator, although connection through a step-up or step-down transmission may clearly also be used if needed.

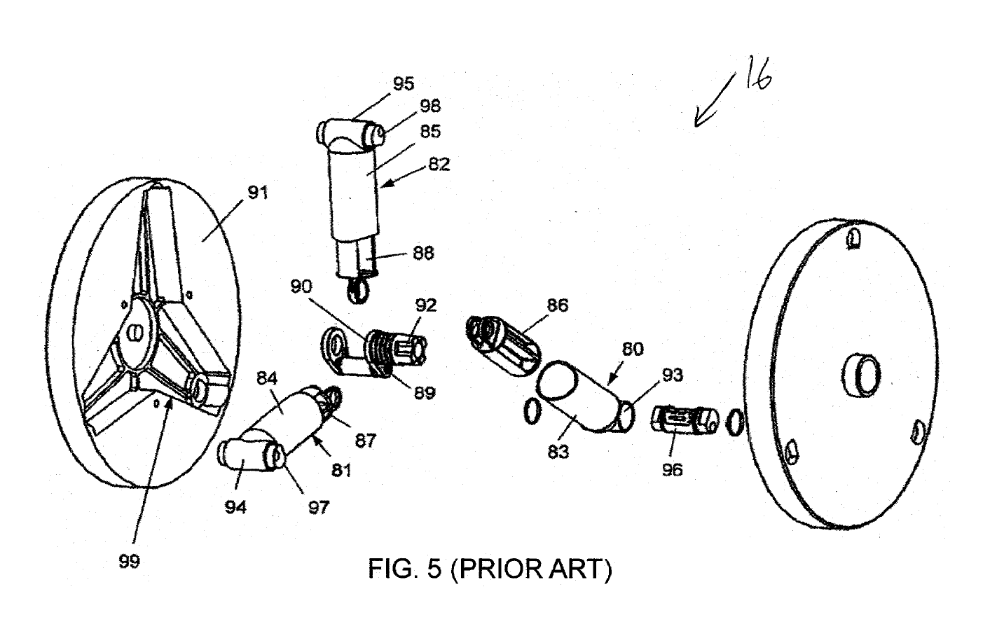

Certain particularly preferred implementation of the present invention employ a positive-displacement motor. One particularly preferred example illustrated here is a piston motor. Water-powered piston motors are known in the art, and may be implemented by way of example according to the teachings of U.S. Pat. No. 7,258,057 which is hereby incorporated by reference in its entirety as if fully set out herein. In particular, FIGS. 8 and 9 thereof, reproduced herein as FIGS. 4 and 5, illustrate a disc-like implementation of a piston motor 16 suitable for use in device 12. Specifically, motor 16 as illustrated here has three connecting-rod assemblies 80, 81 and 82, including three cylinders 83, 84 and 85, respectively, and pistons 86, 87 and 88, respectively. These connecting-rod assemblies drive a crank 89, which is integrally formed with or keyed to an Output shaft 92. In FIG. 5, the device is shown in an exploded perspective view in which a crankshaft 90 is clearly visible. The three cylinders 83, 84 and 85 of the connecting-rod assemblies are provided with transverse sleeves 93, 94 and 95, respectively, for housing valves 96, 97 and 98 respectively. The valves are supported on a trilateral support 99 attached to a support plate 91. It should be noted that the other implementations of water-powered motors described in the '057 patent, for example with reference to FIGS. 6 and 7 thereof, are also suitable for implementation of the present invention.

Further details of a preferred implementation of the connecting-rod assemblies, and the associated valve structures may be found in the description of the aforementioned U.S. Pat. No. 7258,057. Motors implemented according to similar designs are commercially available in products such as automatic garden hose reels (e.g., AQUAWINDER™ auto rewind hose reel commercially available from Suncast Corp., USA) and pool cover rolling mechanisms (e.g., AQUALIFE HYDRO™ automatic pool cover commercially available from Maytronics, France).

In order to achieve the safety advantages offered by the present invention, particularly preferred implementations of aerator device 12 are implemented without any externally-powered electric component. In simple implementations, the operation of the aerator device is purely hydro-mechanical, operating whenever it receives pressurized water flow to its inlet, without any electrical components. In certain cases, it may be desired to incorporate various electrical components, such as sensors for monitoring, properties of the body of water, and/or control components such as valves for controlling operation of the aerator device. In such cases, all electrical components are preferably low-power components operated by power from a local battery pack, which may optionally be a rechargeable battery pack charged by solar cells and/or by a small hydro-electric generator associated with hydraulic motor 14. In all such cases, the absence of externally-supplied electrical power connection to an electrical power grid) renders any risk of electrocution negligible.

Turning now to FIGS. 6 and 7, there is shown a second exemplary implementation of aerator device 12 for use in the system of FIG. 1. In this case, at least part of the mechanical aerator 14 is integrated with a casing 40 of the rotary motor 16, and rotary motor 16 is configured to drive rotation of casing 40 relative to a fixed shaft 42.

This structure may be best understood with reference to the cut-away view of FIG. 7. The motor 16 is essentially similar to the piston motor described above, but instead of a fixed casing with a rotating shaft output, the central shaft 42 is here fixed to a support structure 44 and the casing 40 carrying paddles 30 spins around the shaft. Distribution of the hydraulic fluid to the pistons is achieved via a non-rotating swivel-connection collar 46 which delivers fluid through openings in a sleeve 48 which rotates with casing 40. An internal or external feed tube 50 carries fluid from sleeve 48 to a peripheral fluid distribution channel 52 which provides fluid via the valve assemblies 54 into each cylinder 56, all in a manner analogous to that described above with reference to FIGS. 4 and 5. Sleeve 48 preferably also provides the structural support for the rotatable part of the assembly which is supported via a suitable bearing assembly 58 relative to a central axle 60 integrated as part of support structure 44. Support structure 44 itself may be integrated with a floating platform (not shown) analogous to that of FIGS. 2 and 3. Alternatively, particularly in the case of vertical-walled pools such as used in intensive fish fanning, this device (or that of FIGS. 2 and 3) may be fixed to a wall of the pool, either directly or via a vertically self-adjusting float arrangement.

The integration of the mechanical aerator function with an inverted for of the hydraulic motor provides a particularly compact device which may offer advantages in various applications. In all other respects, the structure and function of the device of FIGS. 6 and 7 will be understood by analogy to the device of FIGS. 2-5 described above.

Although described thus far with reference to one preferred application in the field of aerators for pools, it is noted that similar principles are applicable to any and all motor-driven devices which are to he used at least partially immersed in a body of water. A second group of applications of particular relevance is devices for mixing and circulating water within a pool.

By way of a first example. FIG. 8 illustrates a device 12 with a hydraulic motor 16 driving a mechanical water displacer 14 analogous to a one-sided version of the device of FIG. 2. The device is mounted in a cradle 62 which is vertically displaceable along a rail arrangement 64 for mounting on a wall of a vertical-walled pool, such as is used in intensive fish farming or in water treatment pools. The vertical position of cradle 62 and hence also of device 12 may be selected according to the requirements of the installer either to be partially immersed in the water, in which case the device functions as an aerator as discussed above, or to be entirely immersed (submerged) in the water, in which case the device performs a mixing function.

Turning finally to FIG. 9, this shows an alternative displacer device, generally designated 66 for circulating and mixing water within a body of water. In this case, an impeller 68 is driven by a motor 16 (as described above), which is suspended under the water level by a support structure 70 which hangs from a float 72. A water inlet 74 is shown here on the top surface of float 72, and connects to a tube running within the support structure 70 to motor 16. The exhaust water flow of the motor is released directly into the water from motor 16. In all other respects, the structure and function of displacer device and the associated system are fully analogous to that described above with reference to the aerator devices.

It will be appreciated that the above descriptions are intended only to serve as examples, and that many other embodiments are possible within the scope of the present invention as defined in the appended claims.

What is claimed is:

1. A device for aerating or mixing a body of water, the device comprising:
(a) a mechanical displacer movable so as to displace water of the body of water, thereby aerating or mixing the body of water; and
(b) a hydraulic motor have an inlet for receiving a flow of liquid, said hydraulic motor being connected in driving relation to said mechanical displacer such that a flow of liquid supplied to said inlet is effective to move said mechanical displacer so as to displace water of the body of water.

2. The device of claim 1, wherein said mechanical displacer is an aerator comprising a rotating wheel.

3. The device of claim 2, wherein said mechanical aerator comprises a paddle wheel supporting a plurality of outwardly-projecting paddles.

4. The device of claim 1, wherein said mechanical displacer and said hydraulic, motor are mounted on a buoyant platform comprising at least one float, said buoyant platform being configured to maintain said mechanical displacer in a partially-immersed of fully-immersed state.

5. The device of claim 1, wherein said hydraulic motor is a rotary motor.

6. The device of claim 5, wherein said rotary motor has a rotating output shaft linked so as to rotate at least part of said mechanical displacer.

7. The device of claim 5, wherein at least part of said mechanical displacer is integrated with a casing of said rotary motor, and wherein said rotary motor is configured to drive rotation of said casing relative to a fixed axis.

8. The device of claim 1, wherein said hydraulic motor is a positive-displacement motor.

9. The device of claim 1, wherein said hydraulic motor has an outlet deployed to release the flow of liquid, and wherein said outlet is deployed such that, when the hydraulic motor is driven by a flow of water, the water is released via said outlet into the body of water.

10. The device of claim I, wherein the device has no externally-powered electric component.

11. A system for aerating a body of water, the system comprising:
(a) the device of claim 1 deployed at least partially immersed in the body of water;
(b) a water pump deployed remotely relative to the body of water; and
(c) a length of tubing connected to an outlet of said water pump and to said inlet of said hydraulic motor so as to deliver a flow of water from said water pump to said hydraulic motor, thereby driving said mechanical displacer.

12. The system of claim 11, further comprising a conduit deployed for drawing water from the body of water to an inlet of said water pump such that said hydraulic motor is driven by a flow of water drawn from the body of water.

13. The system of claim 11, wherein said water pump is connected via additional lengths of tubing for driving a plurality of devices deployed in a plurality of bodies of water.

14. A method for aerating or mixing a body of water comprising the steps of:
(a) deploying the device of claim I at least partially immersed in the body of water; and
(b) supplying to said hydraulic motor a flow of water so as to actuate said hydraulic motor, thereby moving said mechanical displacer so as to displace water of the body of water, thereby aerating or mixing the body of water.
